(19) United States
(12) Patent Application Publication
(10) Pub. No.: US 2016/0212948 A1
(43) Pub. Date: Jul. 28, 2016

(54) Automated Greenhouse

(71) Applicant: Ecosphere Technologies, Inc., Stuart, FL (US)

(72) Inventor: Dennis McGuire, Stuart, FL (US)

(21) Appl. No.: 14/950,811

(22) Filed: Nov. 24, 2015

Related U.S. Application Data
(60) Provisional application No. 62/083,747, filed on Nov. 24, 2014.

(51) Int. Cl. A01G 9/24; C02F 1/78; C02F 9/00; C02F 1/36; C02F 1/66; A01G 1/00; C02F 1/461

(52) U.S. Cl. CPC A01G 9/247; A01G 1/001; C02F 1/78; C02F 1/461; C02F 1/36; C02F 1/66; C02F 9/00; C02F 2303/20

(57) ABSTRACT

Disclosed is a fully-automated greenhouse that utilizes hydroponic growing techniques in order to maximize the amount of crop production possible in a given footprint, and eliminates the need for soil, fossil fuels, pesticides and toxic chemicals. The greenhouse produces its own pure, clean water supply with proprietary, on-board atmospheric water generators incorporating water treatment technology, namely ozone, hydrodynamic cavitation, acoustical cavitation, and electrochemical oxidation to oxidize and destroy contaminants to maintain purity.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 62/083,747, entitled “AUTOMATED GREENHOUSE”, filed Nov. 24, 2014. The contents of the above referenced application is incorporated herein by reference.

### FIELD OF THE INVENTION

This invention is directed to the field of greenhouses and, in particular, to a greenhouse having a self-contained water treatment system to provide a sterile environment free for optimum plant growth.

### BACKGROUND OF THE INVENTION

As the earth population grows so does the demand for more food. The current attempts to increase food production to meet the growth of the population has led to development of plant production through the use of herbicides, fertilizer and other chemical additives, which in turn causes more pollution of soil, water and air. The problem with pollution is that it carries from one location to another. A growing region that is polluting the soil will cause pollution of the water supply that is fed to a growing region downstream entering the food change wherein plants, animals and humans are affected. The risk of food safety hazards and quality of food grown is directly related to the quality of the water and associated environmental conditions surrounding the growing region.

Cultivating other high-value crops, “farm-to-table” and organic movements where the growing, harvesting, and consumption could all be accomplished at a restaurant, hotel, university or the like location is an engaging market. The ability to grow such crops while keeping such crops safe from predators is extremely important. Crops are known to draw many types of predators, although in urban areas the predators may be more limited to human than to animal. While an animal can quickly destroy a plant, a human could steal a plant even faster. Further, crops are exposed to all types of weather conditions including winds, rain and seasonal variations. A current crop sought by retailers is marijuana which illustrates the aforementioned problem. For instance, marijuana can damaged by drought, too much rain, high winds, theft by individual or animal.

Known prior art include Freight Farms™, a company that “retrofits shipping containers with LEDS, climate controls, and hydroponics, turning them into growing containers.

PharmPods™ are based on shipping containers to be housed inside warehouses or other similar spaces. The concept is that a farmer can maximize the growing potential in a space not typically used for agriculture. And it allows for the potential to grow in urban settings or areas with climates that typically require produce to be imported.

FusionPharm's™ are standard ISO steel shipping containers that are repurposed for use in indoor plant cultivation. Stackable and scalable the containers allow an environment in the agriculture industry that makes vertical farming economically possible.

Growtainer™ is a modular and mobile vertical production environment constructed from a 40-foot insulated shipping container that has been modified to provide a controlled vertical environment for growing horticultural and agricultural products in all environments and climates.

CannaPods™ are cannabis grow rooms built with an exoskeleton for strength. This allows the pod to be portable, easy to construct and stack.

PodPonics™ use shipping container to grow produce. The system uses software and hardware to grow lettuce and other leafy greens year-round, without soil, sunlight or pesticides. Using hydroponics, the crops are grown in vertical tiers inside former shipping containers, which range from 320 to 450 square feet.

GrowTrucks™ are multiple growing environments based upon a box truck namely freight container and semi-trailer platforms featuring full-size 53-foot tractor trailer. The containers offer portable farming space, or a 40-foot freight container platform, that is a modular unit.

What is lacking in the art is a turn-key growing system that employs hydroponic growing techniques using advanced oxidation processes to enhance plant growth for creation of a sterile environment.

### SUMMARY OF THE INVENTION

Disclosed is a fully-automated greenhouse that utilizes hydroponic growing techniques in order to maximize the amount of crop production possible in a given footprint, and eliminates the need for soil, fossil fuels, pesticides and toxic chemicals. The greenhouse produces its own pure, clean water supply with proprietary, on-board atmospheric water generators incorporating water treatment technology, namely ozone, hydrodynamic cavitation, acoustic cavitation, and electrochemical oxidation to oxidize and destroy contaminants to maintain purity.

An objective of the invention is to provide a turn-key greenhouse that is fully operational upon delivery and is capable of producing greater and higher quality crop yields in a given footprint when compared to conventional hydroponic gardening techniques.

Still another objective of the invention is to provide a greenhouse that is hydroponic and can grow organic crops without soil, fossil fuels, pesticides or toxic chemicals in any environment or climate.

Another objective of the invention is to provide a greenhouse having a surveillance system that enables remote monitoring of crops via smartphone, tablet or any web-enabled computer device.

Another objective of the invention is to provide a greenhouse that is sustainable by producing its own pure, clean water supply with proprietary, on-board atmospheric water generators incorporating water treatment technology, namely ozone, hydrodynamic cavitation, acoustical cavitation, and electrochemical oxidation to oxidize and destroy contaminants to maintain purity.

Still another objective of the invention is to provide a greenhouse that can be transported anywhere in the world via truck, train, ship or plane.

Another objective of the invention is to provide a greenhouse particularly applicable to high-value crop cultivation such as essential oils, urban farming, on-site cultivation for hotels, restaurants, universities and large personnel bases, and legal marijuana cultivation.

Other objectives and further advantages and benefits associated with this invention will be apparent to those skilled in the art from the description, examples and claims which follow.

### BRIEF DESCRIPTION OF THE DRAWINGS

FIG. 1 is a pictorial view of the greenhouse.

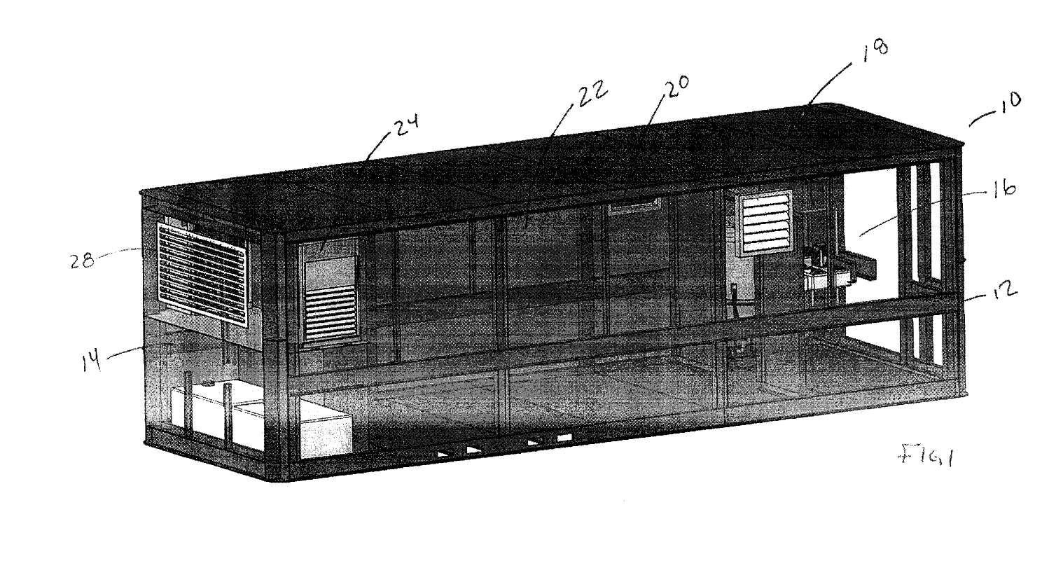

FIG. 2 is a pictorial flow diagram of the nutrient mixing and feed system.

FIG. 3 is a pictorial flow diagram of the atmospheric water generator and leachate mixing water treatment system.

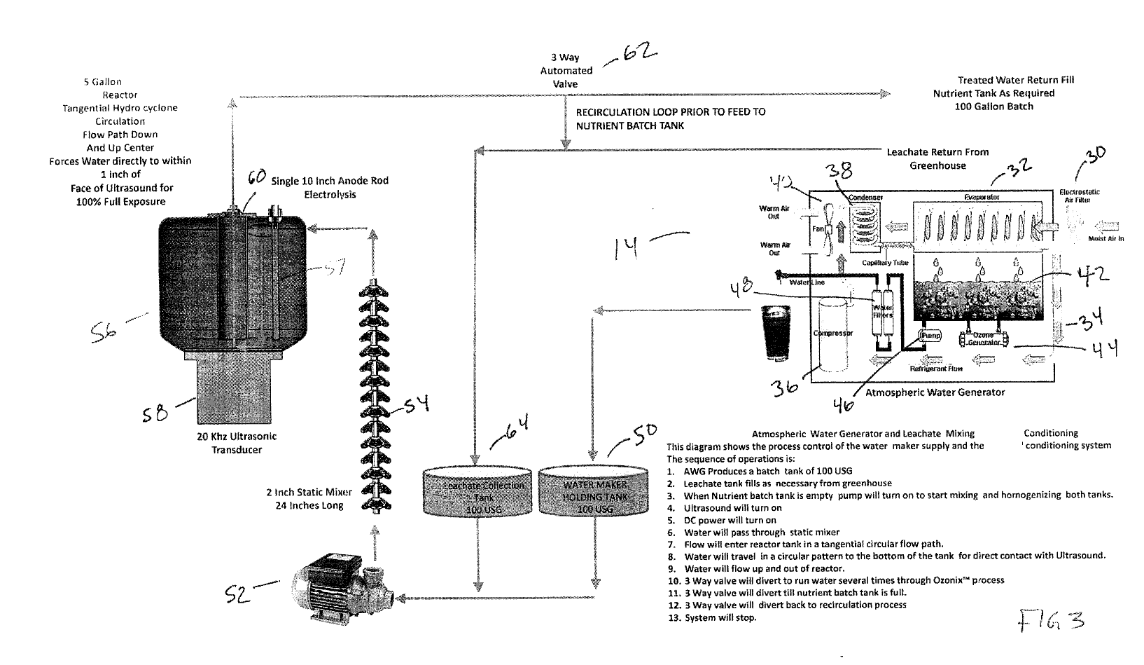

FIG. 4 is a pictorial flow diagram of the climate control system and air circulation system.

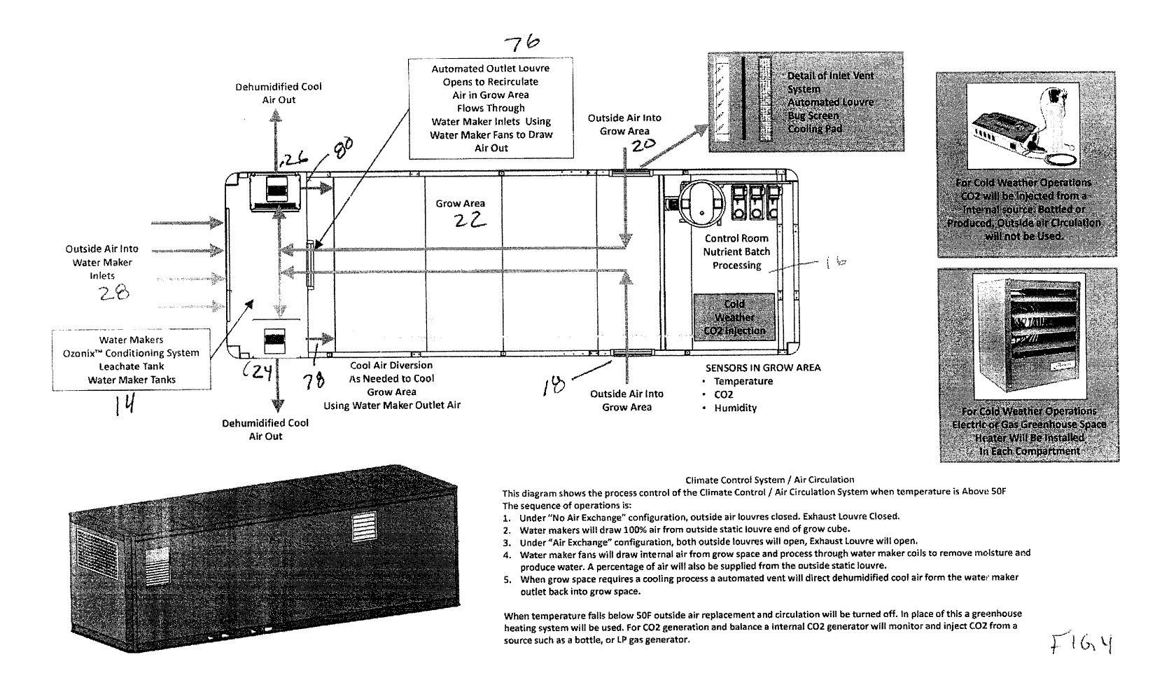

FIG. 5 is a chart of system controls.

FIG. 6 is a flow diagram of the nutrient control system.

FIG. 7 is a flow diagram of the water treatment system.

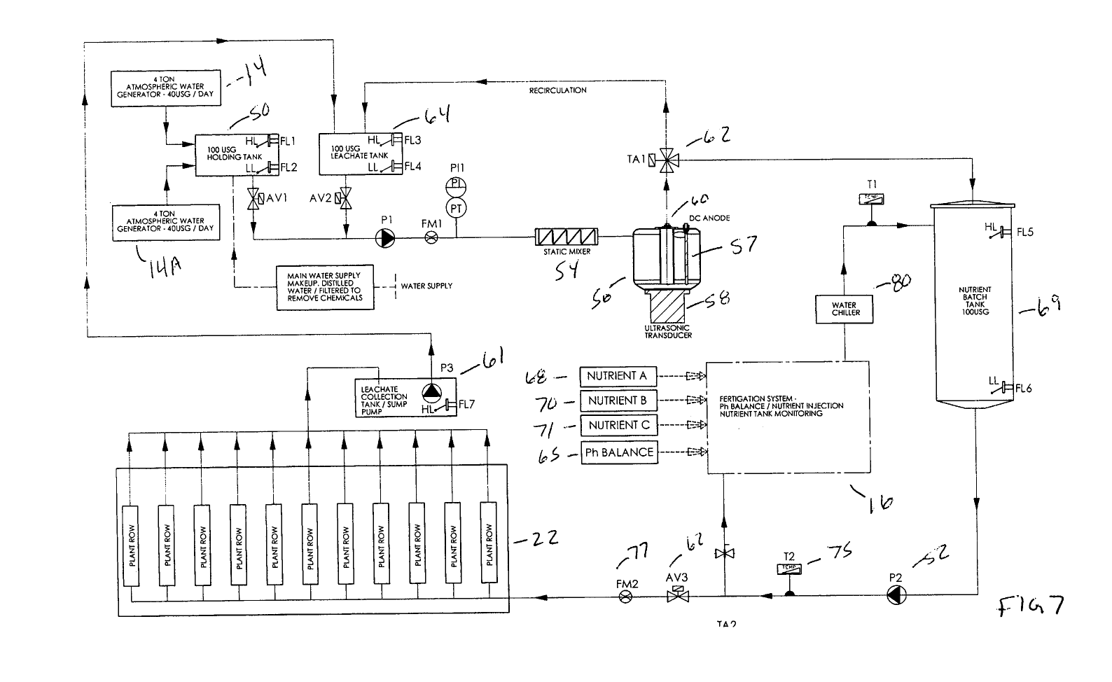

FIG. 8 is a flow diagram of the process flow using Ozonix® reactor.

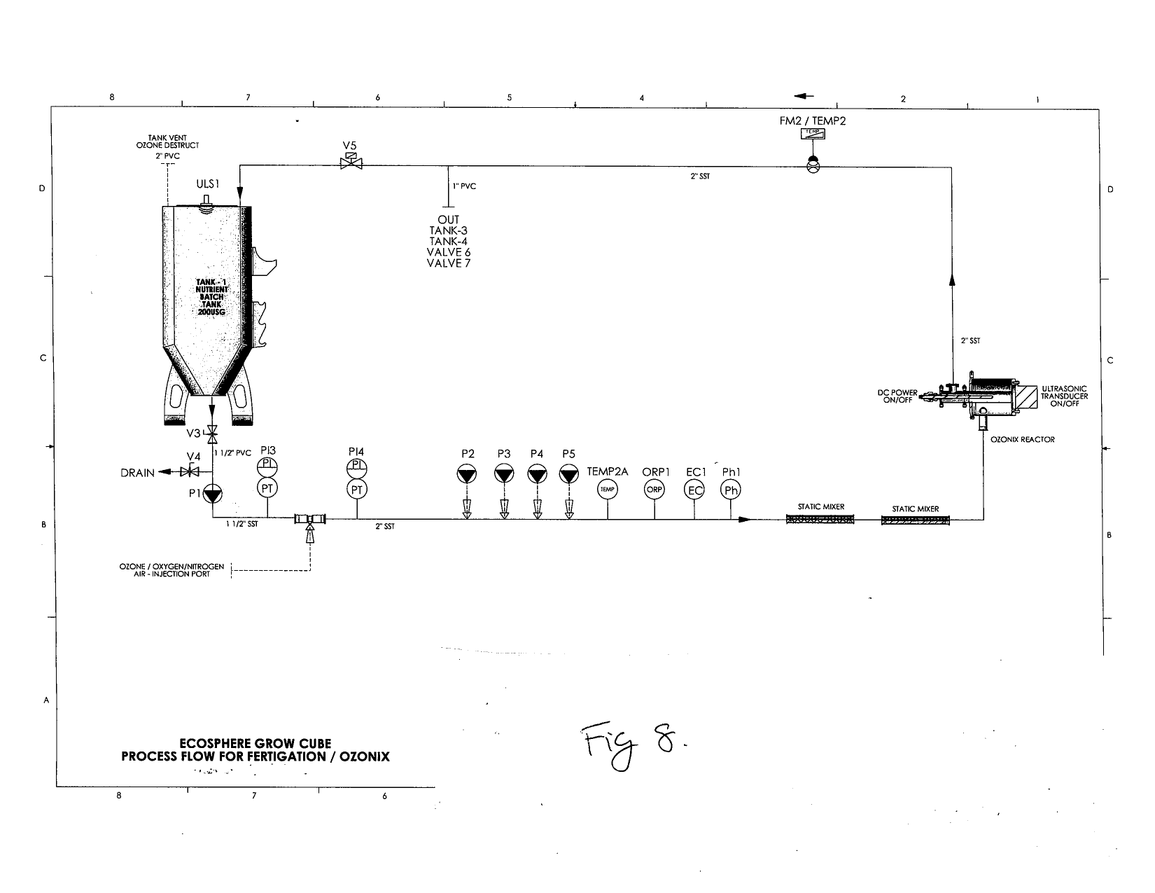

FIG. 9 is a flow diagram of the HVAC system.

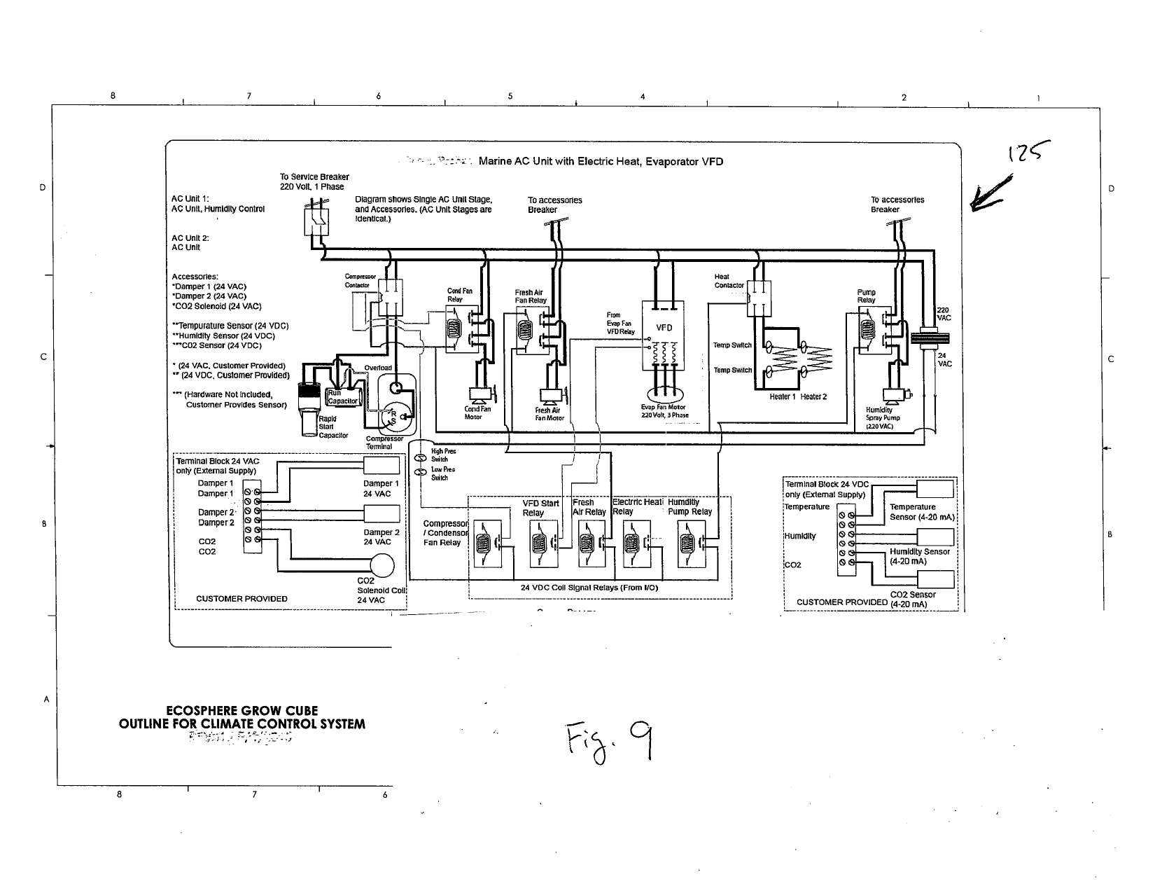

FIG. 10 is a flow diagram of the process flow for deep water culture.

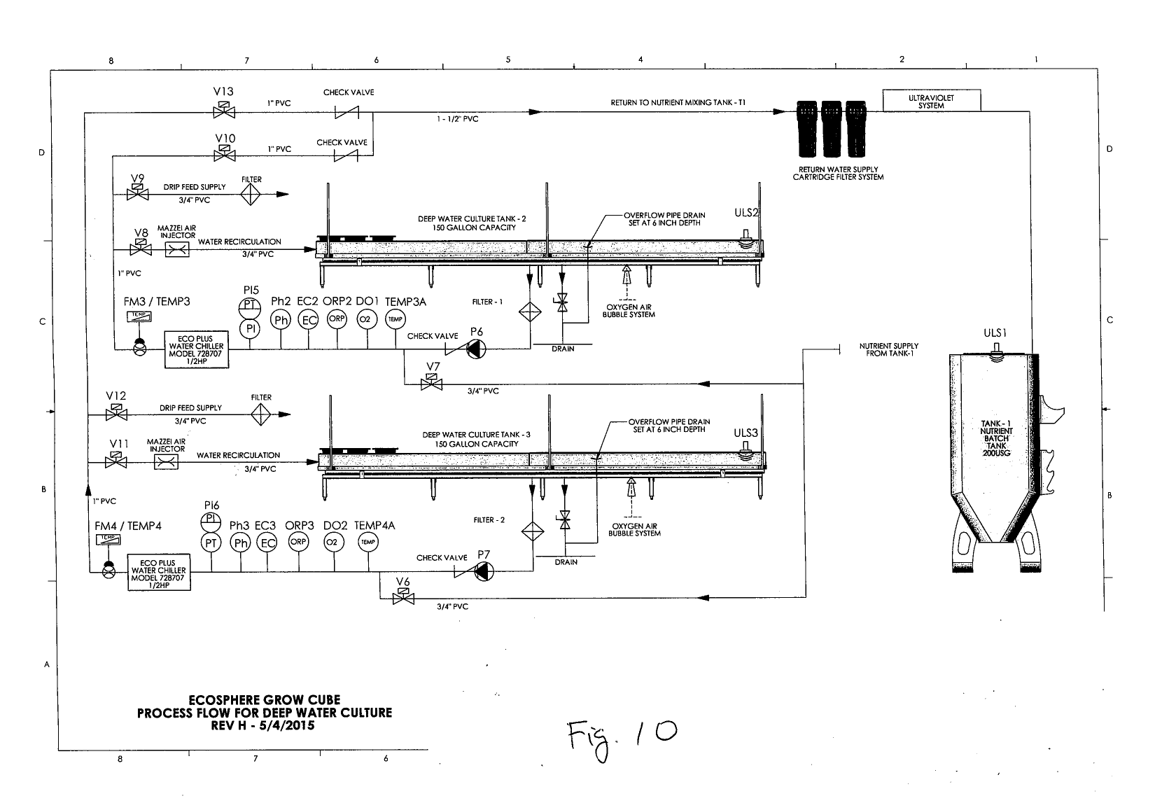

### DETAILED DESCRIPTION OF THE PREFERRED EMBODIMENT

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

Hydroponics is a method of growing plants using mineral nutrient solutions in water, without soil. Operators in this industry generally grow crops under glass or other protective cover. The benefits of hydroponics are widely known and understood, and include: increased crop yield, shorter growing cycle, can be performed indoors, reduced labor and environmentally sound. In an urban area growing station pollution affects not only the immediate area but can also cause pollution to the general population if the waste is not properly controlled. Individuals who are knowledgeable about food growth, as well as those in the compassionate care industry, e.g. medical marijuana, understand the need for pure water for the strains of plants that are being grown for consumption as well as used in medicines to treat children seizures, cancers, etc. Conventional tap water or bore well water can have pathogens dangerous to plants and also some of the microorganisms can decrease the level of nutrients added to the water. The processed water should eliminate these pathogens and help in plant growth.

The instant invention is fully-automated greenhouse that utilizes hydroponic growing techniques in order to maximize the amount of crop production possible in a given footprint, and eliminates the need for soil, fossil fuels, pesticides and toxic chemicals.

Referring to the Figures, the hydroponic greenhouse 10 that is fabricated out of aircraft-grade aluminum 12 with a water maker system 14 and a control system 16 that enables control of all the important growing parameters, including: ambient temperature, root system temperature, humidity, CO₂ concentration, and lighting. Air entry vents 18 and 20 allow filtered air into the growing area 22. Dehumidified cool air is expelled through exit vents 24 and 26. The water maker system 14 draws air though end vent 28.

Expectations regarding plant yields based upon a single unit having a 60 foot length, 12 foot width and a 9.5 foot height for growing a crop containing 180 plants. Each crop is expected to yield 4 to 6 ounces per plant with six harvest cycle times per year. The estimated number of units required to produce the estimated total demand of legal marijuana in the U.S. would be: 12,900 to 19,400 units to produce 5.2 million pounds cultivated annually in all 50 states; 8,900 to 13,300 units to produce 3.6 million pounds cultivated annually under the most likely progression of legalization; and 5,900 to 8,800 units based on 2.4 million pounds cultivated annually in states with either currently legalized recreational use of marijuana or such initiatives.

The water maker system has a vent 28 with an electrostatic air filter with moist air being drawn past an evaporator 32. The evaporator 32 is based upon a refrigerant flow having a compressor 36 for the refrigerant placed through a condenser 38 with a fan 40 expelling hot air through the exit vents 24 and 26. Condensate is collected and ozonated 44 and then pumped 46 through water filters 48 to a holding tank 50. At least one water maker 14 is employed, namely a 4 ton atmospheric water generator capable of about 40 USG/day, wherein multiple water makers 14A may be placed in parallel.

The atmospheric water generator system 14 extracts water from ambient air to eliminate the need to use “city or tap water” and all of its associated contaminants. Many cities rely on antiquated water delivery systems and treatment technology. Aging pipes can break, leach contaminants into the water they carry and breed bacteria. Conventional water treatment plants are designed to filter particles in the water and kill some parasites and bacteria but generally fail to remove modern contaminants like pesticides, industrial chemicals and arsenic, lead, pathogens and a variety of toxic chemicals.

The Applicant has been awarded patents for unique processes that employ cost-effective on-site cavitation reactors that combines ozone, hydrodynamic cavitation, ultra-sound and electro-precipitation (see U.S. Pat. Nos. 7,699,994; 7,699,988; 7,785,470; 8,318,027; 8,721,898 and 8,858,064 the contents of which are herein incorporated by reference).

The water treatment system of the instant invention employs ozone, hydrodynamic cavitation, acoustical cavitation, and electrochemical oxidation to oxidize and destroy contaminants. Ozone is added to the condensate 42 in an amount to operate as an oxidizing agent (E°=+2.07V) that can react with most species containing multiple bonds (such as C═C, C═N, N═N, etc.) at high rates and also result in significant degree of disinfection. These oxidations are simple and the mechanisms only require contact of ozone with the chemical constituents. Although the thermodynamics for ozone-induced oxidation is favorable due to ozone's high reduction potential, kinetic factors will most often dictate whether ozone will give required degree of treatment in a reasonable time frame. Thus a combination of ozone with additional techniques give better contact and mass transfer rates to result in a significant degree of process intensification.

The filtered and ozonated fluid is pumped 52 out of the holding tank 50 and drawn through a two inch diameter by 24 inch long static mixer 54 at a rate that causes hydrodynamic cavitation and results in the creation of highly reactive free radicals and turbulence to provide the intensification of various physical/chemical operations of the ozonated water. Cavitation as used in this invention is defined as the combined phenomena of the formation, growth and subsequent collapse of micro bubbles or cavities occurring over an extremely small interval of time releasing large magnitudes of energy at the location of transformation. Cavitation herein includes ultrasound cavitation which when combined with the hydrodynamic cavitation is efficient in bringing about a desired chemical/physical change in water. Hydrodynamic cavitation is generated by using an orifice plate with the flowing fluid expanding as pursuant to Bernoulli's equation. At the orifice plate, kinetic energy of the liquid increases at the expense of pressure head sufficient to cause the pressure around the pressure heat to fall below a threshold pressure for cavitation wherein cavities are generated. Subsequently, as the liquid expands reducing the average velocity and the pressure increases resulting in the collapse of the cavities. Hydrodynamic cavitation takes place by the flow of a liquid under controlled conditions through various geometries. The phenomenon consists in the formation of hollow spaces which are filled with a vapor gas mixture in the interior of a fast flowing liquid or at peripheral regions of a fixed body which is difficult for the fluid to flow around and the result is a local pressure drop caused by the liquid movement. At a particular velocity the pressure may fall below the vapor pressure of the liquid being pumped, thus causing partial vaporization of the cavitating fluid. With the reduction of pressure there is liberation of the gases which are dissolved in the cavitating liquid. These gas bubbles also oscillate and then give rise to the pressure and temperature pulses. The mixing action is based on a large number of forces originating from the collapsing or implosions of cavitation bubbles. If during the process of movement of the fluid the pressure at some point decreases to a magnitude under which the fluid reaches a boiling point for this pressure, then a great number of vapor filled cavities and bubbles are formed. Insofar as the vapor filled bubbles and cavities move together with the fluid flow, these bubbles move into an elevated pressure zone. Where these bubbles and cavities enter a zone having increased pressure, vapor condensation takes place within the cavities and bubbles, almost instantaneously, causing the cavities and bubbles to collapse, creating very large pressure impulses. The magnitude of the pressure impulses with the collapsing cavities and bubbles may reach ultra high pressure implosions leading to the formation of shock waves that emanate from the point of each collapsed bubble. The spectacular effects of cavitation are used in combination with the electrolysis and an ultrasonic transducer to cause acoustic cavitation.

Ultrasonic leads to an increase of concentration of microcells and also influences favorable change of the pH of the water. The pH changes after the water treatment and so does the electrical potential measured in terms of the ORP. These changes are used to assure nutrients can be better digested by the plants. Typically these will be uniformly mixed in the water due to the microscale turbulence generated by cavitation and easily taken up during the process. A sonoluminescence effect is observed due to acoustic cavitation as these ultrasonic waves propagate in the water and catch the micro bubbles in the valley of the wave. Sonoluminescence occurs whenever a sound wave of sufficient intensity induces a gaseous cavity within a liquid to quickly collapse. This cavity may take the form of a pre-existing bubble, or may be generated through hydrodynamic and acoustic cavitation. Sonoluminescence can be made to be stable, so that a single bubble will expand and collapse over and over again in a periodic fashion, emitting a burst of light each time it collapses. The frequencies of resonance depend on the shape and size of the container in which the bubble is contained. The light flashes from the bubbles are extremely short, between 35 and few hundred picoseconds long, with peak intensities of the order of 1-10 mW. The bubbles are very small when they emit light, about 1 micrometer in diameter depending on the ambient fluid, such as water, and the gas content of the bubble. Single bubble sonoluminescence pulses can have very stable periods and positions. In fact, the frequency of light flashes can be more stable than the rated frequency stability of the oscillator making the sound waves driving them. However, the stability analysis of the bubble shows that the bubble itself undergoes significant geometric instabilities, due to, for example, the Bjerknes forces and the Rayleigh-Taylor instabilities. The wavelength of emitted light is very short; the spectrum can reach into the ultraviolet. Light of shorter wavelength has higher energy, and the measured spectrum of emitted light seems to indicate a temperature in the bubble of at least 20,000 Kelvin, up to a possible temperature in excess of one mega Kelvin. The veracity of these estimates is hindered by the fact that water, for example, absorbs nearly all wavelengths below 200 nm. This has led to differing estimates on the temperature in the bubble, since they are extrapolated from the emission spectra taken during collapse, or estimated using a modified Rayleigh-Plesset equation. During bubble collapse, the inertia of the surrounding water causes high speed and high pressure, reaching around 10,000 K in the interior of the bubble, causing ionization of a small fraction of the noble gas present. The amount ionized is small enough for the bubble to remain transparent, allowing volume emission; surface emission would produce more intense light of longer duration, dependent on wavelength, contradicting experimental results. Electrons from ionized atoms interact mainly with neutral atoms causing thermal bremsstrahlung radiation. As the ultrasonic waves hit a low energy trough, the pressure drops, allowing electrons to recombine with atoms, and light emission to cease due to this lack of free electrons. This makes for a 160 picosecond light pulse for argon, as even a small drop in temperature causes a large drop in ionization, due to the large ionization energy relative to the photon energy. The electrochemical production of hydroxyl radicals and their role in electrochemical oxygen transfer reactions depend on the electrode material used. The mechanism of hydroxyl radical's formation depends also on the electrical potential. These radicals are then more or less strongly adsorbed at the surface.

A reactor tank 56 employs a single ten inch anode rod to cause electrolysis before the ultrasonic transducer 58 adds to the ozonated water. The reactor tank 56 is about 5 gallons having a tangential hydro cyclone circulation flow path down along the sides of the tank and up a center pathway 60 forcing the water to within 1 inch of the fact of the ultrasound transducer to assure 100 exposure of the water to the acoustic cavitation. The purified water is directed to the plant growth area wherein an automated 3 way valve 62 can is used to direct the filtered water to either the growing area or for admixing with a leachate collection tank 64. Leachate from the plants is collected in a tank/sump 61 and returned from the greenhouse and run through the water maker system, less the direct ozone injection. A water chiller 80 can be employed in areas having high ambient temperatures.

This treatment allows recycled water to be used while killing bacteria and increase plant yield. The treatment system eliminates the use of harmful treatment chemicals and renders the ozone-based disinfectant methods much more effective. The water will intensify plant and root system growth. One theory of the better growth rate is through the micro-sizing of nutrients for more efficient plant uptake. The combination of ultrasonic and hydrodynamic cavitation micro mixes the plant nutrients to create a nano-emulsion. The ozone saturated water produced by the treatment process is environmental friendly and cleaner by decontaminating the air in the greenhouse to eradicate odors, bacteria and contaminants within the growing area. The disclosed system makes available to small growers commercial-grade and proprietary hydroponic growing technologies and components, which not only increase yields and shorten harvest cycles, but also produce a “pure” “higher quality” product.

The atmospheric water generator and leachate mixing water treatment system has a sequence of operation:

1. The atmospheric water generator produces a batch tank 50 of 100 U.S. gallons.

2. The Leachate tank 64 fills as necessary from the greenhouse return.

3. When the nutrient batch tank is empty 69, the recirculation pump will turn on to start mixing and the tank.

4. Ultrasound will turn 58 on.

5. DC power will turn on the pump 52.

6. Water will pass through static mixer 54.

7. Flow will enter the reactor tank 56 in a tangential circular flow path.

8. Water will travel in a circular pattern to the bottom of the tank 56 for direct contact with ultrasound 58.

9. Water will flow up and out of reactor 60.

10. The 3 Way valve 62 will divert to run water several times through the water treatment process.

11. The 3 Way valve 62 will divert until the nutrient batch tank is full 69.

12. The 3 Way valve 62 will divert back to recirculation process.

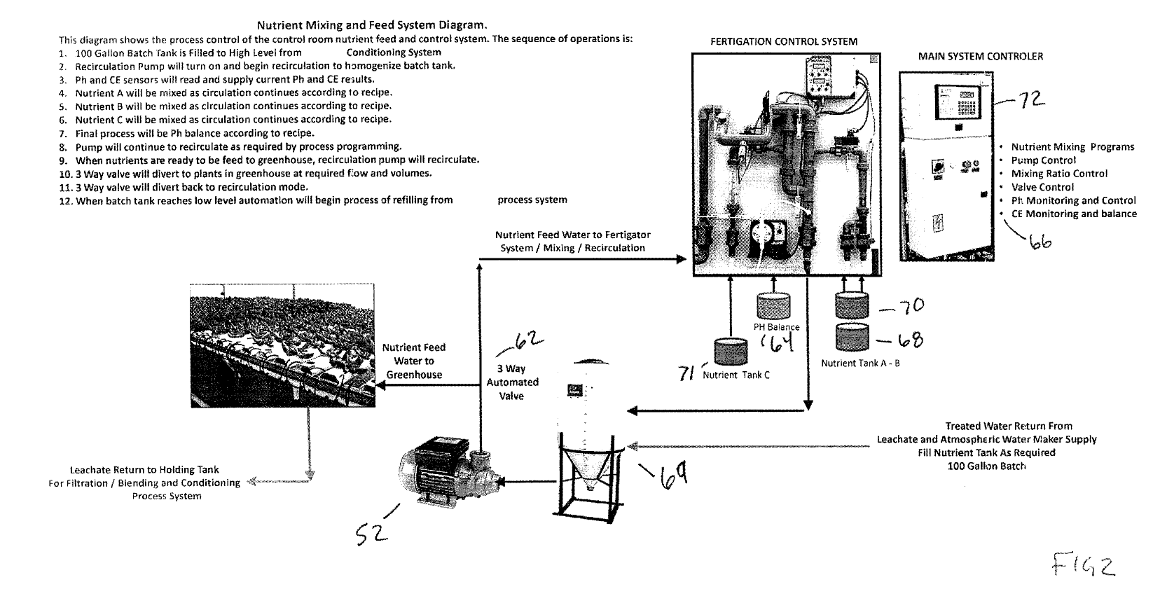

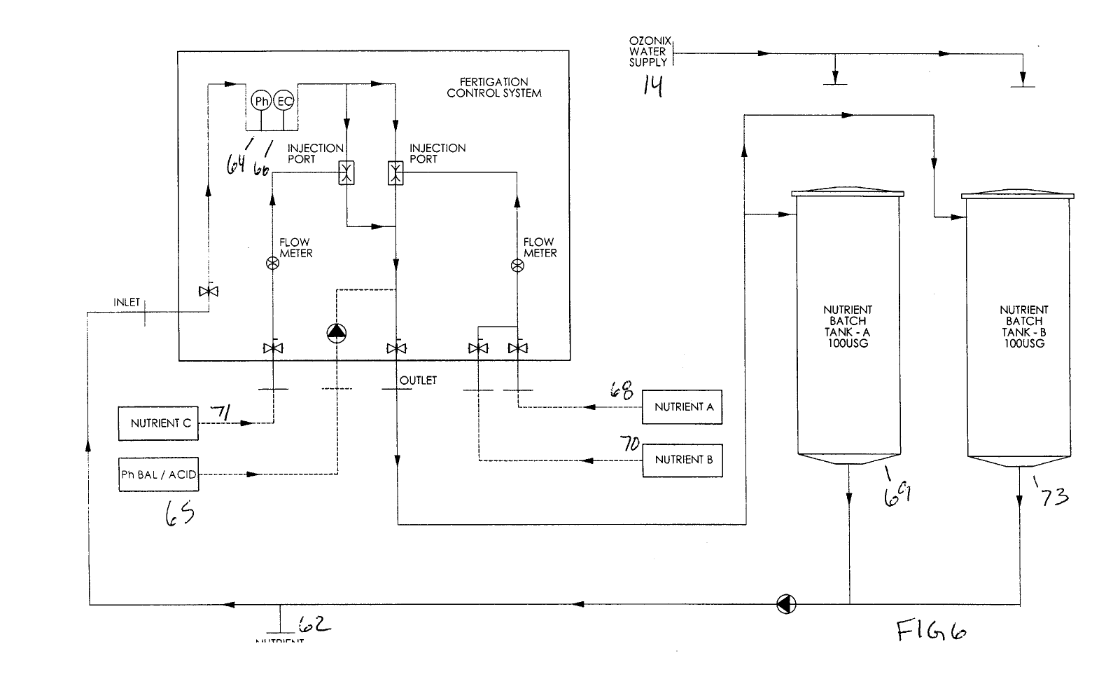

From the nutrient batch tank 69, the pump 52 flows the fluid past a temperature sensor 75 through the automated three way valve 62 with the flow rate monitored by a flow meter 77. FIGS. 2 and 6 depict the nutrient mixing and feed system diagram of the instant invention. This diagram shows the process control of the control room nutrient feed and control system. The sequence of operations is:

1. filling at least one 100 Gallon Batch Tank 69 from the water treatment Conditioning System 14;

2. recirculating the water with a pump 52 within the tank 69 to create a homogenize batch tank;

3. monitor pH 64 and CE 66 from sensors to read and adjust the pH by injection 65;

4. adding nutrients A 68, B 70 and C 71 to the batch tank 64 as circulation continues;

5. balancing pH according to a predetermined recipe;

6. continue recirculating the nutrient treated batch tank fluid as required by process programming 72;

7. forward the nutrient treated batch tank 69, when nutrients are ready to be feed to greenhouse, through the automated three way valve;

8. divert treated fluid to plants in greenhouse at predetermined flow rates and volumes;

9. return to recirculation mode; and

10. refill batch tank upon low level automation from the water treatment Conditioning System.

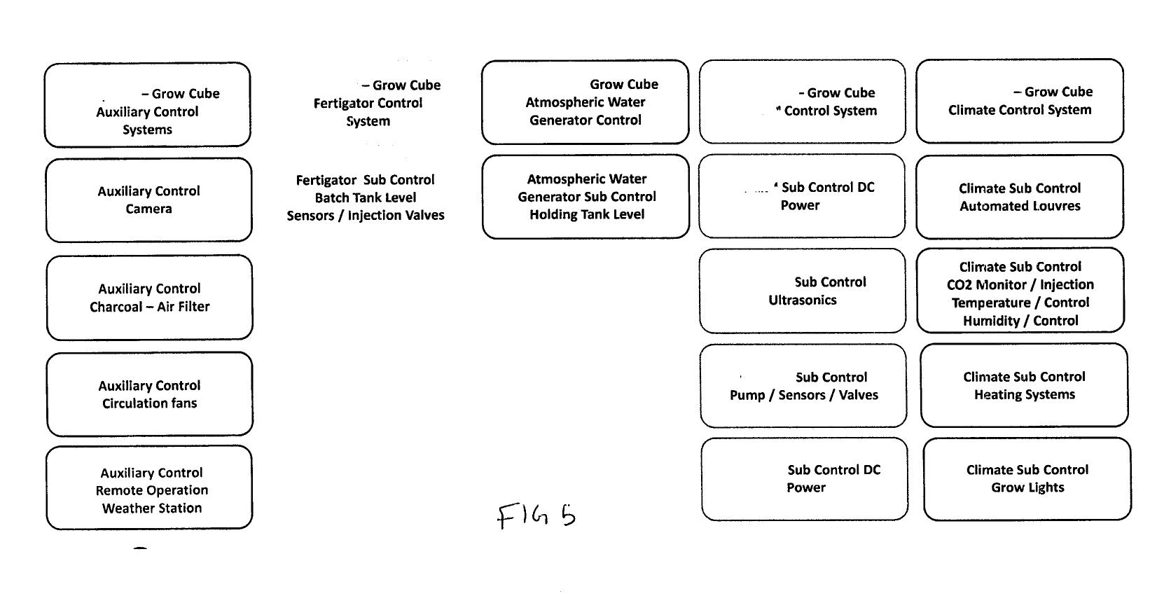

Additional batch tanks 73 can be added depending upon the crop water requirements. The greenhouse includes a “no air exchange” configuration when outside air louvers are closed on all vents. For cold weather operation, CO2 is injected, no outside air is circulated, and an electric or gas space heater is placed within the greenhouse. In normal operation the water makers will draw 100% of the air through the vents 18 and 20. Automated outlet louver 76 open to recirculate air in the grow area with fans 24 and 25 to draw the non-recirculate air out of the greenhouse. When the grown space requires a cooling process an automated vent 78 and 80 will direct dehumidified cool air from the water maker back into the grow area 22. A double door system is fed with positive pressure from the HVAC system so that when the door is opened airborne bacteria are kept out of the growing space. FIG. 5 depicts the control routines for the system to monitor and control sub systems based upon a main PLC and a HMI control system.

In a preferred embodiment, the grow room is separated from the control room. A 7 ton HVAC system 125 is provided to maintain optimal climate conditions. Additionally, the HVAC system is constructed and arranged to provided positive pressure into the grow room to eliminate the introduction of bacteria and other diseases when an operator opens the door to the grow room.

The combined system allows monitoring and control of 9 important limiting factors that affect plant growth:

1. Temperature around the plant canopy.

2. Humidity around the plants.

3. CO₂ concentration around the leaves of the plants.

4. Light at the top of the canopy.

5. Temperature of the water delivered to the roots.

6. pH of the water.

7. Electro conductivity of the water (nutrient strength).

8. Dissolved oxygen in the water.

9. Oxygen Reduction Potential (ORP) of the water.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Various modifications of the described modes for carrying out the invention which are obvious to those skilled in the art are intended to be within the scope of the claims.

What is claimed is:

1. A water process for a greenhouse system comprising the steps of:
fluidly coupling an atmospheric water generator, injecting ozone into water collected from said generator,
filtering the ozonated water,
directing the ozonated water through a static mixer at a rate to induce hydrodynamic cavitation,
receiving the ozonated water with induced cavitation into a reactor tank having at least one anode rod to induce electrolysis,
passing the ozonated water with induced cavitation subjected to electrolysis past an ultrasonic transducer to induce acoustic cavitation to form a treated fluid;
introducing the treated fluid into a greenhouse;
collecting leachate fluid from the greenhouse,
directing a blend of leachate fluid with the ozonated water through the static mixer at a rate to induce hydrodynamic cavitation,
receiving the blend of leachate fluid and ozonated water with induced cavitation into a reactor tank having at least one anode rod to induce electrolysis;
passing the blend of leachate fluid and ozonated water with induced cavitation subjected to electrolysis past an ultrasonic transducer to induce acoustic cavitation to form a treated fluid; introducing the treated fluid into the greenhouse.

2. The water process for a greenhouse system according to claim 1 including the steps of adjusting the pH of the treated fluid and adding nutrients to the treated fluid to form a nutrient feed water; wherein said nutrient feed water delivered to plants in the greenhouse.

3. The water process for a greenhouse system according to claim 2 including a nutrient tank for storing said nutrient fluid.

4. The water process for a greenhouse system according to claim 3 including the step of recirculating said nutrient fluid stored in said nutrient tank and monitoring for temperature and pH.

5. The water process for a greenhouse system according to claim 2 including the step of adjusting the temperature of said nutrient fluid.

6. The water process for a greenhouse system according to claim 1 wherein said reactor tank is sealed to receive pressurized water.

7. The water process for a greenhouse system according to claim 1 wherein said reactor tank is constructed and arranged to provide a tangential hydro cyclone circulation from a top of the tank to a bottom of the tank passing within 1 inch of a 20 KHz ultrasonic transducer.

8. The water process for a greenhouse system according to claim 1 including the steps of creating a pressure greater than atmospheric pressure within said reactor tank.

9. The water process for a greenhouse system according to claim 1 wherein the atmospheric water generator and equipment for ozonating, static mixer, reactor tank with anode rod and ultrasonic transducer is installed within a container that can houses a growing area forming a unit that can be shipped one well site to another by truck, rail or ship.

10. The water process for a greenhouse system according to claim 1 including sectioning said greenhouse into at least two compartments wherein at least one compartment is constructed and arranged for growing plants.

11. The water process for a greenhouse system according to claim 1 including connecting an HVAC system constructed and arranged to control the climate.

12. The water process for a greenhouse system according to claim 11 wherein said HVAC system supplies positive pressure to said compartment used for growing plants constructed and arranged to prevent bacteria and other diseases from entering said compartment.
